(19) United States
(12) Patent Application Publication
(10) Pub. No.: US 2017/0098829 A1
(43) Pub. Date: Apr. 6, 2017

(54) NON-PRECIOUS FUEL CELL CATALYSTS COMPRISING POLYANILINE

(71) Applicant: Los Alamos National Security, LLC, Los Alamos, NM (US)

(72) Inventors: Piotr Zelenay, Los Alamos, NM (US); Gang Wu, Los Alamos, NM (US)

(21) Appl. No.: 15/291,014

(22) Filed: Oct. 11, 2016

Related U.S. Application Data
(62) Division of application No. 13/267,579, filed on Oct. 6, 2011.
(60) Provisional application No. 61/390,380, filed on Oct. 6, 2010.

(51) Int. Cl. H01M 4/90; H01M 8/1004; H01M 8/1018

(52) U.S. Cl. CPC H01M 4/9008; H01M 4/9083; H01M 8/1018; H01M 8/1004; H01M 2008/1095

(57) ABSTRACT

A method of producing a catalyst suitable for use in a membrane electrode assembly involves providing a mixture comprising a polyaniline precursor and a catalyst support; adding to said mixture an oxidant and a compound comprising a transition metal; agitating said mixture sufficiently to result in polyaniline polymerization; drying the mixture; heating the dried mixture in an inert atmosphere at a temperature of from about 400° C. to about 1000° C.; leaching the mixture with an acid solution; heating the resulting mixture in an inert atmosphere at a temperature of from about 400° C. to about 1000° C. The second heating improves the performance of the catalyst.

### CROSS-REFERENCE TO RELATED APPLICATIONS

This application is a divisional of U.S. application Ser. No. 13/267,579 filed Oct. 6, 2011, which claims the benefit of U.S. Provisional Patent Application No. 61/390,380 filed Oct. 6, 2010, the entire content of all of which is incorporated herein.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

The present invention relates to non-precious metal catalysts, suitable for use, e.g., in the oxygen-reduction reaction (ORR) in fuel cells, which are based on the heat treatment of polyaniline/metal/carbon precursors.

### BACKGROUND OF THE INVENTION

Polymer electrolyte fuel cells (PEFCs) operated on hydrogen fuel and air (i.e., oxygen) are considered a viable technology for powering vehicles. The cost of the platinum catalysts is prohibitive in PEFCs, especially at the high loadings required for the oxygen reduction reaction (ORR). As a result, the development of non-precious metal catalysts (NPMCs) with high ORR activity has become a major focus of PEFC research. Early work examined the pyrolysis of transition metal-containing macrocycles, resulting in ORR catalysts with promising yet insufficient activity and durability. Later studies replaced the expensive macrocycle precursors with a wide variety of common nitrogen-containing chemicals (ammonia, acetonitrile, amines, etc.), transition metal inorganic salts (sulfates, nitrates, acetates, hydroxides and chlorides), and carbon supports. From these studies, it was learned that the heat treatment of almost any mixture of (1) nitrogen, (2) carbon, and (3) metal precursors will result in a material that is ORR active; however, the degree of activity and durability depend greatly on the selection of precursors and synthetic method.

Although great advances have been recently made, no single material yet meets both the activity and durability requirements of fuel cell operation. A designed approach based on the nature of the active site(s) would be desirable, but no conclusive description has yet been presented for any catalyst type. Experimental characterization and identification of active sites remains a challenge, because non-precious metal catalytic (NPMC) materials prepared by heat treatment are inherently highly heterogeneous. Additionally complicating the analyses is the fact that species at the surface—defined in this context as the topmost atomic layer—are much more important for catalysis than the bulk composition, and no suitable surface probes for NPMCs have yet been developed. A vigorous debate has thus ensued regarding whether metal atoms participate directly in active sites, or merely catalyze the formation of active sites from carbon, nitrogen, and perhaps oxygen atoms. Metals could also play a secondary role by forming metal oxides that decompose peroxide. Importantly, nearly all proposed active site structures involve nitrogen incorporated into carbon, whether the nitrogen species are bound to metal centers or not. Although catalysts with a certain degree of activity for the ORR can be prepared without any detectable metal content, the presence of metal is required to generate the most active and durable catalysts known to date.

A need exists, therefore, for non-precious metal catalysts (NPMCs) for the oxygen reduction reaction (ORR) that can successfully replace platinum would dramatically reduce costs and make fuel cells far more competitive.

### SUMMARY OF THE INVENTION

The present invention relates to non-precious metal catalysts which are prepared by the heat-treatment of polyaniline, metal, and carbon precursors. Suitable salts of transition metals for preparing catalyst compositions of this invention include salts of iron (Fe) and cobalt (Co). These salts may include a variety of counterions such as, but not limited to, nitrate (NO₃⁻), bicarbonate (HCO₃⁻), carbonate (CO₃⁻²), RCO₂⁻ (for example, acetate (CH₃CO₂⁻), formate (HCO₂⁻), hydrogen sulfate (HSO₄⁻), sulfate (SO₄⁻²), fluoride (F⁻), chloride (Cl⁻), bromide (Br⁻), and iodide (I⁻). Variation of the heat-treatment temperature, post-processing steps, metal loading, and the transition metal (Fe versus Co) results in catalysts with markedly different activity, composition, and structure.

An embodiment of this invention relates to a composition produced by a process comprising:

forming a cold aqueous suspension of carbon and aniline,

forming a first product by combining the suspension with an oxidant and a transition metal-containing compound and allowing the resulting mixture to react under conditions suitable for polymerization of the aniline to polyaniline, the transition metal containing compound including a metal selected from iron and cobalt,

drying the first product,

heating the dry first product at a temperature of from about 600° C. to about 1000° C. to form a second product,

leaching the second product with acid, and thereafter

repeating the step of heating at a temperature of from about 600° C. to about 1000° C. In a preferred embodiment, the first heating is at a temperature of about 900° C. and the second heating (i.e. the heating after the leaching step) is at a temperature of about 900° C.

Another embodiment of this invention relates to a composition produced by a process comprising:

forming a cold aqueous suspension of carbon and aniline,

forming a first product by combining the suspension with an oxidant and a transition metal-containing compound and allowing the resulting mixture to react under conditions suitable for polymerization of the aniline to polyaniline, the transition metal containing compound including a metal selected from iron and cobalt,

drying the first product,

heating the dry first product at a temperature of from about 400° C. to about 1000° C. to form a second product,

leaching the second product with acid, and thereafter

repeating the step of heating at a temperature of from about 600° C. to about 1000° C. to form a third product, and thereafter

combining the third product with a solution including a perfluorinated sulfonic acid ionomer. In a preferred embodiment, the first heating is at a temperature of about 900° C. and the second heating is at a temperature of about 900° C.

Yet another embodiment of this invention relates to a membrane electrode assembly comprising a composition prepared by a process comprising:

forming a cold aqueous suspension of carbon and aniline,

forming a first product by combining the suspension with an oxidant and a transition metal-containing compound and allowing the resulting mixture to react under conditions suitable for polymerization of the aniline to polyaniline, the transition metal containing compound including a metal selected from iron and cobalt,

drying the first product,

heating the dry first product at a temperature of from about 600° C. to about 1000° C. to form a second product,

leaching the second product with acid, and thereafter

repeating the step of heating at a temperature of from about 600° C. to about 1000° C. to form a third product, and thereafter

combining the third product with a solution including a perfluorinated sulfonic acid ionomer. In an preferred embodiment, the first heating is at a temperature of about 900° C. and the second heating is at a temperature of about 900° C.

Another non-limiting embodiment of this invention relates to a method of producing a catalyst suitable for use in a membrane electrode assembly. A mixture including a polyaniline precursor and a catalyst support is provided. An oxidant and a compound comprising a transition metal is added to the mixture, followed by agitating the mixture sufficiently to result in a polymerization to form a polyaniline-containing product. The polyaniline-containing product is dried and heated in an inert atmosphere at a temperature of from about 400° C. to about 1000° C. Afterward, the heating, the resulting mixture is leached with an acid solution, and then heated in an inert atmosphere at a temperature of from about 400° C. to about 1000° C. Another embodiment of the invention is a catalyst product formed by this process.

According to another embodiment of the present invention, a membrane electrode assembly is provided, comprising the catalyst produced according to the method of the first embodiment.

### BRIEF DESCRIPTION OF THE DRAWINGS

FIG. 1A shows RDE activity, FIG. 1B shows fuel cell performance of PANI-Fe—C catalyst before the acid leach (AL) and after the second heat treatment (H2); and FIG. 1C shows durability of PANI-Fe—C after second heat treatment.

FIG. 2A provides a graph of RRDE polarization data showing ORR activity and FIG. 2B provides a graph showing peroxide generation of PANI-Fe—C catalysts as a function of heat-treatment temperature in the catalyst synthesis.

FIG. 3A shows the effect of heat-treatment temperature on FT-IR spectra of PANI-Fe—C catalysts, and FIG. 3B shows the effect of heat-treatment temperature on XRD patterns of the PANI-Fe—C catalysts.

FIG. 4A shows the Fe2p and N1s results of elemental qualification analysis of PANI-Fe—C catalysts using XPS; FIG. 4B shows the C1s and O1s results of elemental qualification analysis of the PANI-Fe—C catalysts using XPS.

FIG. 5 shows several SEM images of PANI-Fe—C catalysts as a function of heat-treatment temperature (scale bar is 500 nm).

FIG. 6 shows the effect of iron content in reaction mixture on ORR activity. The fluctuation of E_{1/2} between catalyst batches is around ±10 mV, making the 3 wt %, 10 wt %, and 30 wt % catalysts statistically equivalent.

FIG. 7A shows Tafel plots of ORR for PANI-Co—C catalysts at various rotating speeds in oxygen saturated 0.5 M H₂SO₄ electrolyte; and FIG. 7B shows Tafel plot of ORR for PANI-Fe—C catalysts at various rotating speeds in oxygen saturated 0.5 M H₂SO₄ electrolyte.

FIG. 8A shows N1s spectra of XPS analysis for PANI-derived PANI-Co—C catalysts: FIG. 8B shows N1s spectra of XPS analysis for PANI-derived PANI-Fe—C catalysts; FIG. 8c shows N1s spectra of XPS analysis for EDA-derived EDA-Co—C catalysts; and FIG. 8D shows N1 s spectra of XPS analysis for EDA-derived EDA-Fe—C catalysts.

FIG. 9 shows HR-TEM and STEM images for PANI-Co—C and PANI-Fe—C catalysts.

FIG. 10A shows XRD patterns for different metal-free samples, FIG. 10B shows XRD patters for PANI-Co—C at different stages in synthesis, FIG. 10C shows XRD patterns for PANI-Fe—C catalysts at different stages in synthesis.

FIG. 11A shows the radial distribution functions (RDFs) of PANI-Fe—C and PANI-Co—C, FIG. 11B shows the RDFs of PANI-Co—C, and FIG. 11C shows the RDFs of PANI-Fe—C catalysts. FIGS. 11D and 11E show comparisons of the catalyst RDFs to the RDFs of metal sulfides.

### DETAILED DESCRIPTION OF THE INVENTION

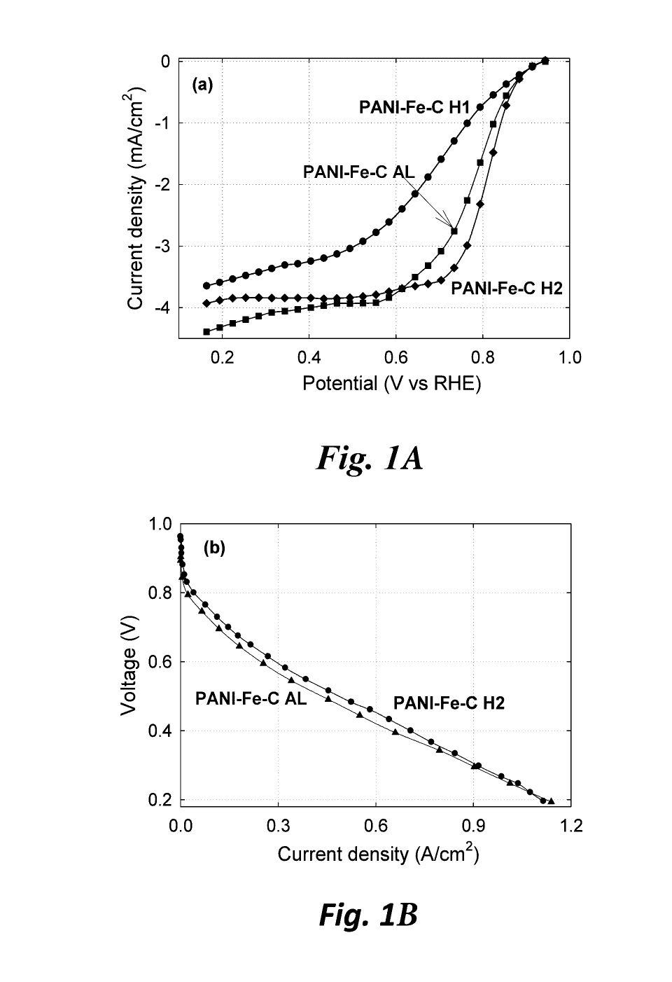

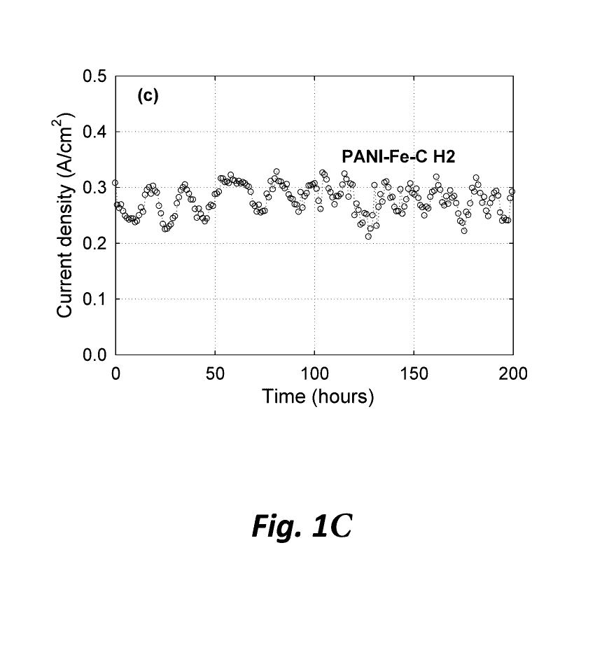

Effect of stages in catalyst synthesis. In catalyst synthesis, the different stages including the first heat treatment (H1), the acid leach (AL), and the second heat treatment (H2) play important roles in achieving good performance of PANI-derived catalysts. The RDE and fuel cell ORR activities of PANI-Fe—C samples at different stages of the synthesis are shown in FIGS. 1A-1C. The first heat treatment creates active sites as evidenced by the RDE curve, but the acid-leaching step results in much higher ORR activity due to the removal of unstable phases from the porous catalyst surface. The half-wave potential (E_{1/2}) of the ORR polarization plot shifts positively by nearly 100 mV. Applying a second heat treatment after the acid-leaching step further improves the ORR activity as measured by both RDE (FIG. 1A) and fuel cell testing (FIG. 1B). A positive shift of ˜30 mV in E_{1/2} occurs, despite some decrease in the mass-transport limited current observed at higher potentials. The formation of new active sites may occur on surfaces or in pores freed from inactive iron oxides and sulfides, whereas the reduced mass transport performance suggests some surface area and/or pores were lost overall. The fuel cell performance is also enhanced by the second heat treatment. In this case, its effect on the wetting properties of the catalyst may also be important, especially that the preceding acid-leaching step had created many oxygen-containing, hydrophilic groups.

In contrast to recent work that generated catalysts with impressive activity from carbon supports with phenanthroline/Fe acetate-filled pores, the first heat treatment is much more important to the activity than the second one for these catalysts, and no ammonia gas is involved in the synthesis. These facts imply significant differences between the active site formation processes of the two types of catalyst. Overall, the activity of PANI-Fe—C catalysts depends far less on the intrinsic porosity of the chosen carbon support than previously synthesized catalysts prepared from pore-filled carbons, based on our observation that we can prepare PANI-derived catalysts of similar activity from supports with vastly different surface areas, porosity, and initial disordered carbon content (which can lead to porosity if NH₃ is used). In fact, we have prepared PANI-derived catalysts with similar activity to those discussed herein using low surface area TiO₂ supports. Apparently, the carbon phases derived from the polymer itself are capable of hosting a significant number of active sites without the need for the carbon support to act as a microporous template. The activity of PANI-derived catalysts is not as high as the previously reported INRS catalysts, but the durability is significantly better as shown in FIG. 1c. The fuel cell performance remains constant at 0.25 A/cm² for 200 h of testing at 0.40 V.

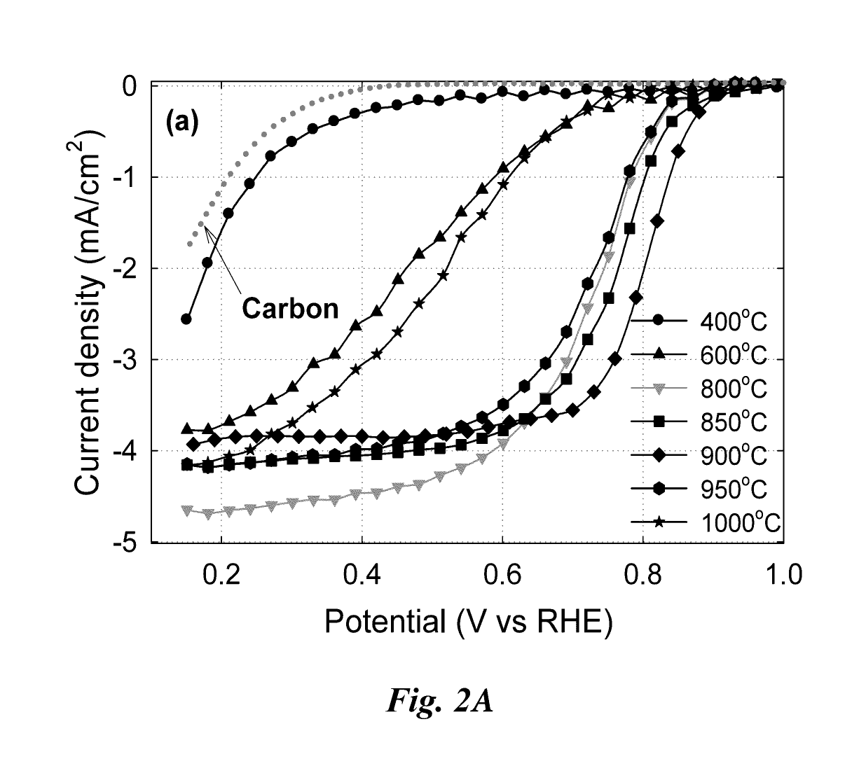

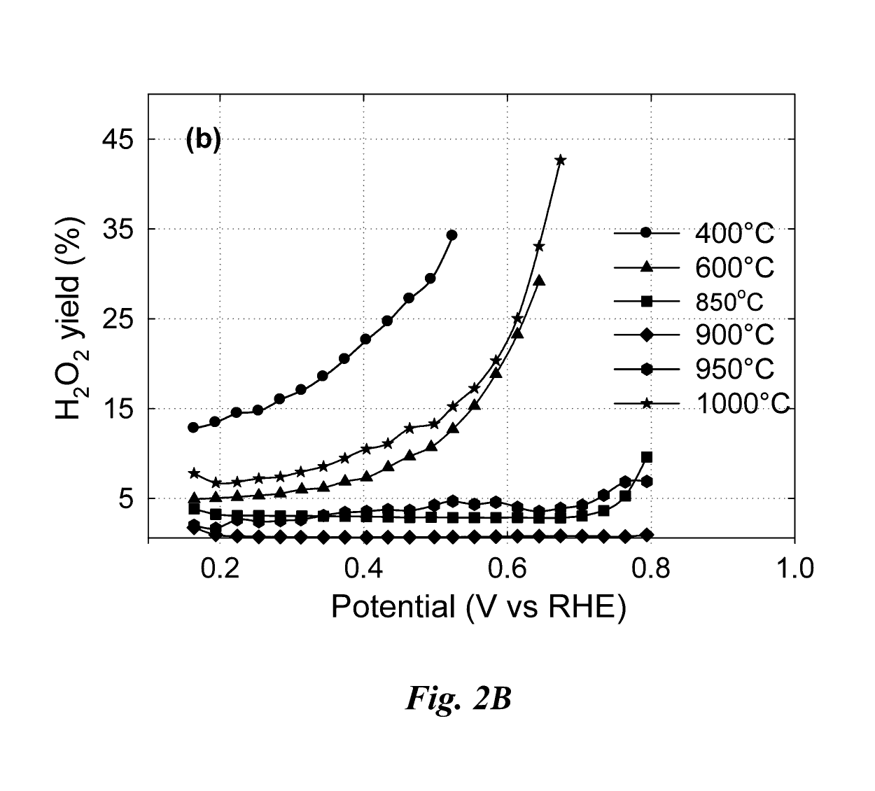

Effect of heating temperature. Because the active sites are known to form during heat treatment, the activity of these sites should be greatly dependent on the heating temperature in the catalyst synthesis. The ORR activities of PANI-Fe—C catalyst were studied as a function of heating temperature ranging from 400° C. to 1000° C. as shown in FIG. 2. The poor activity after 400° C. treatment is very similar to that of carbon materials, but after 600° C. treatment a significant positive shift of the ORR onset potential is observed, demonstrating that active site formation has occurred. In terms of the onset and half-wave potentials (0.93 V and 0.81 V vs. RHE) as well as H₂O₂ yield (below 1%), 900° C. is the optimal temperature. Unless otherwise stated, 900° C. was selected as the heat-treatment temperature for the remainder of the catalysts described herein.

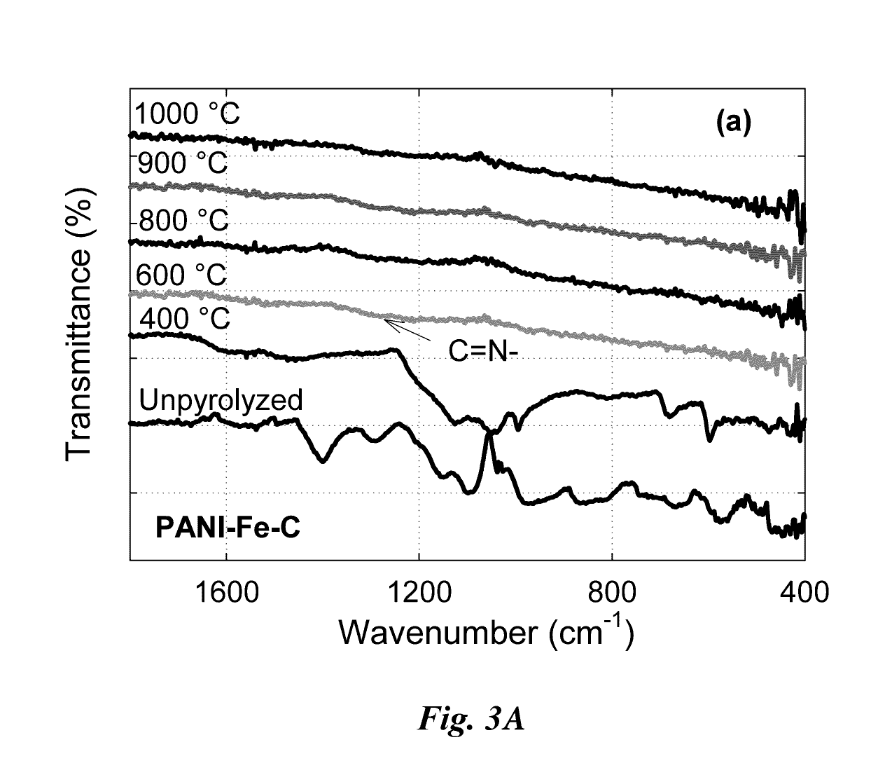

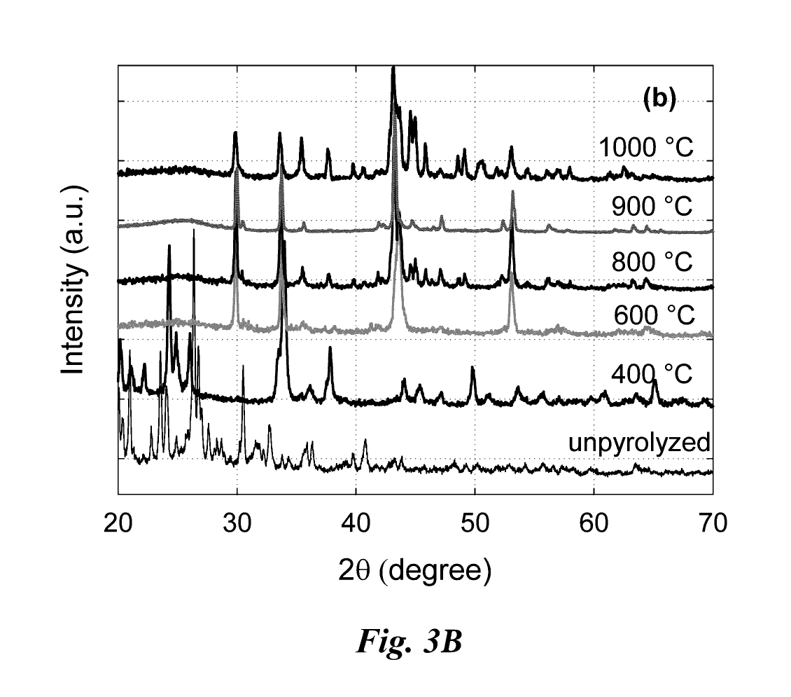

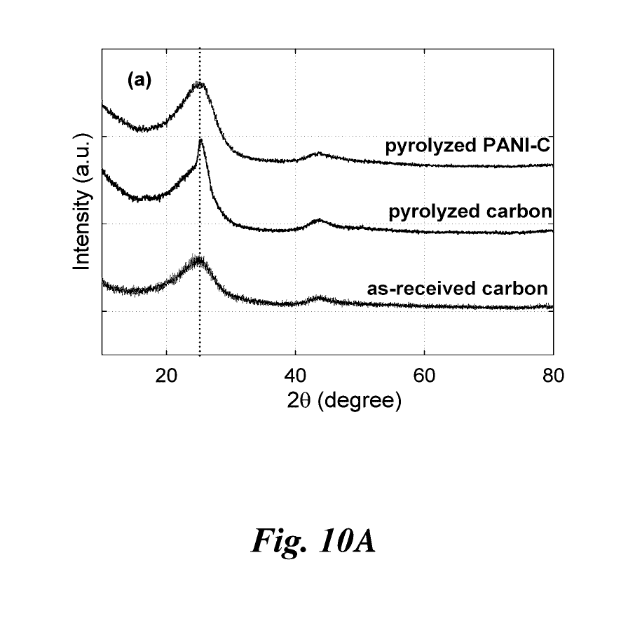

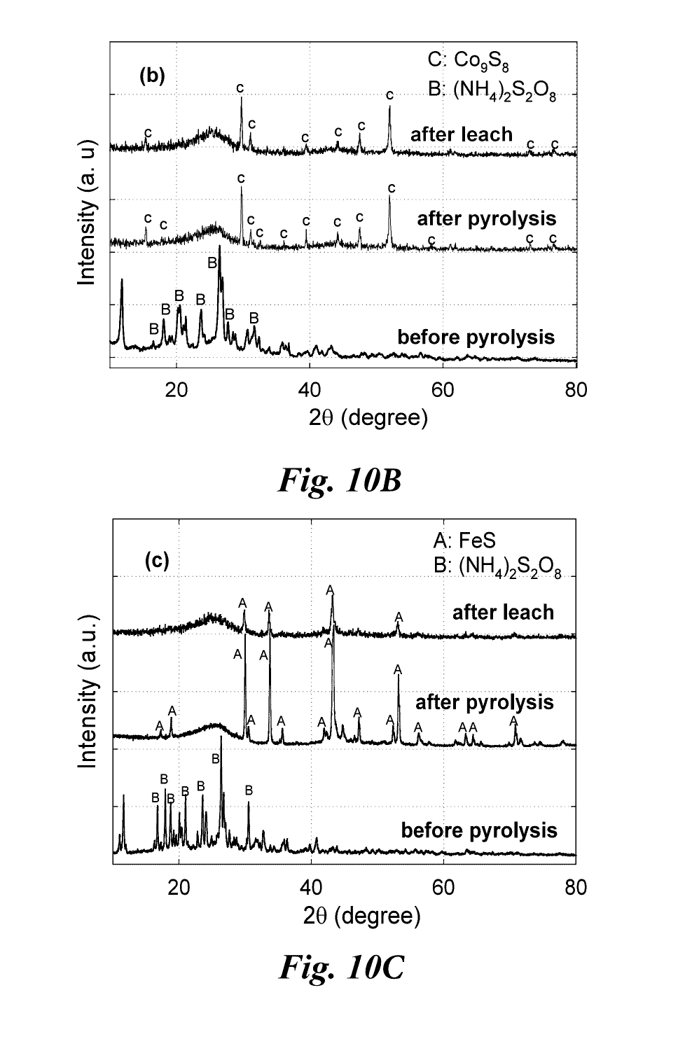

To better understand how the heating temperature affects the ORR activity of these catalysts, extensive physical characterization was conducted. First, FT-IR analysis indicated that the benzene-type (1100 cm⁻¹) and quinone-type (1420 cm⁻¹) structures on the main chain of PANI have broken into smaller fragments (such as C═N) starting with the 600° C. sample (FIG. 3A). This corresponds well to the appearance of ORR activity as shown by the RRDE data. XRD was used to analyze samples after the first heat treatment (before acid leaching), displayed in FIG. 3B. The non-heat-treated PANI-Fe—C sample, containing 10 wt % of Fe, shows well-developed crystalline structures, assignable mainly to the excess of the oxidant APS (2θ=17.6°, 18.2°, 22.2°, 26.6° and 30.4°) and small amount of iron salts (2θ=31.2°, 36.4° and 45.1°). The crystalline peaks for excess oxidant and PANI disappear at 600° C., in agreement with the IR results. At the same time, large quantities of FeS (2θ=17.1°, 18.7°, 29.9°, 31.9°, 33.7°, 35.7°, 43.3°, 47.2°, 54.0°, 63.5° and 70.8°) appear when temperatures reached 600° C. and become dominant at 900° C. The sulfur source in the PANI-catalyst system derives from (NH₄)₂S₂O₈ used to polymerize aniline. Iron sulfides have been shown previously to have limited ORR activity, but not comparable to these catalysts. Importantly, the removal of most of the iron sulfides through the acid-leaching step increases rather than decreases the ORR activity. (As an example, the changes in the XRD pattern after acid leaching and the second heat treatment for the most active PANI-Fe—C-900° C. catalyst can be seen below in FIG. 10C, only a small amount of FeS remains.) Around 1000° C., iron oxides (Fe₂O₃, Fe₃O₄) are formed, which corresponds to the observed decrease in the ORR activity in RDE testing. The appearance of additional crystalline forms of iron implies a loss of highly-dispersed active centers.

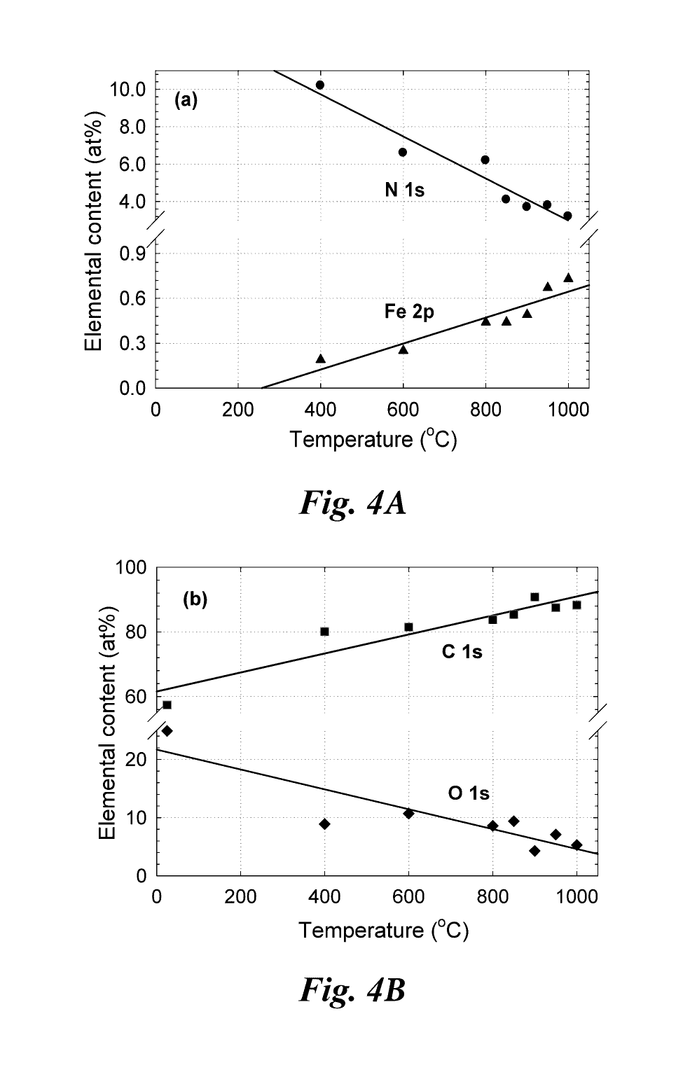

Elemental quantification of the near-surface layers of samples treated at different temperatures was performed using XPS as shown in FIGS. 4A-4B. The near-surface Fe and C contents increased with heat-treatment temperature, primarily due to the significant and expected loss of oxygen and nitrogen species. It is of special note that nitrogen content decreased with heating temperatures from 600° C. to 900° C. without leading to a drop of ORR activity in this temperature range. The activity is not dependent on the total amount of incorporated nitrogen as elsewhere claimed. Even the lowest observed nitrogen content here of 3.5 at % is greater than or equal to that of many other active NPMCs, suggesting that the nitrogen content is sufficient and should not limit the activity in these catalysts. Using XPS, the nitrogen speciation was analyzed for each sample treated at different temperatures. The content and relative ratios of different types of nitrogen e.g., imine (398 eV), pyridinic (398.9 eV), pyrrolic (400.5 eV), quaternary (401.1 eV) and NO (402.9 eV) change with heat-treatment temperature. The peak at binding energy of 398.9 eV may also include a contribution from nitrogen bound to metal. The shift between N-Me (˜399.2 eV) and N in pyridinic environment (398.2-399 eV) is quite small, making it difficult to differentiate between them quantitatively. We chose to use one peak which we will refer to as pyridinic. The ratio of quaternary to pyridinic nitrogen increases, but no single type of nitrogen content correlates well with the ORR activity.

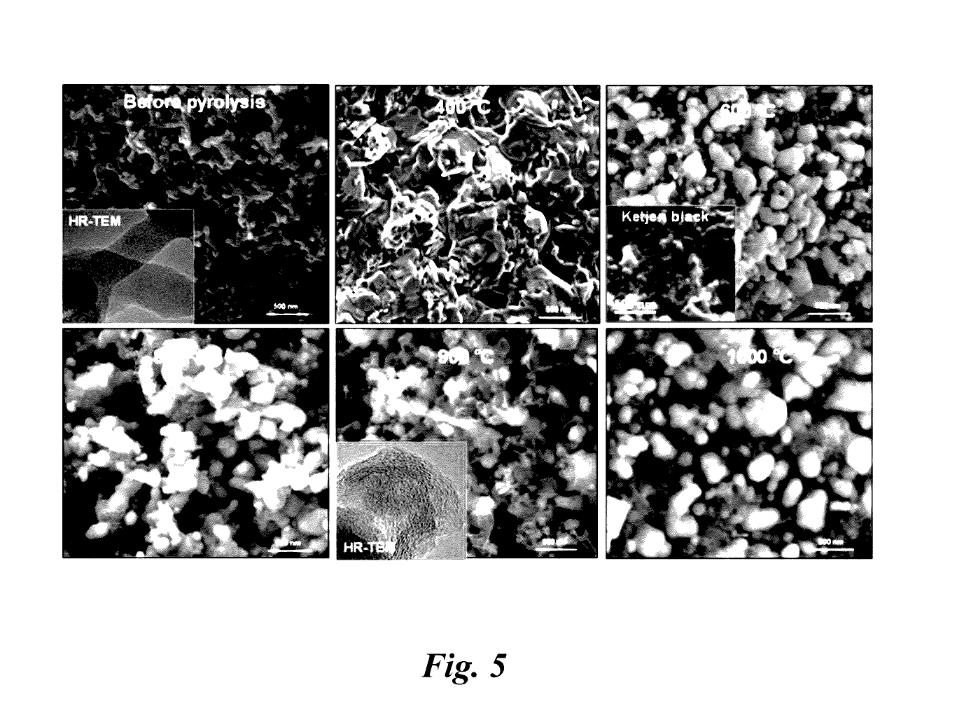

The catalyst morphology as a function of heating temperature was studied using SEM as shown in FIG. 5. The typical PANI nanofibers gradually disappeared as heat-treatment temperature increased to 400° C., with spherical particle formation beginning at 600° C. The SEM images suggest that a dominant graphitic structure in the form of carbon nanofiber with high surface area was formed at 900° C. At 1000° C., however, the morphology becomes non-uniform with the formation of larger agglomerated particles compared with the original carbon black, resulting in a large reduction in surface area.

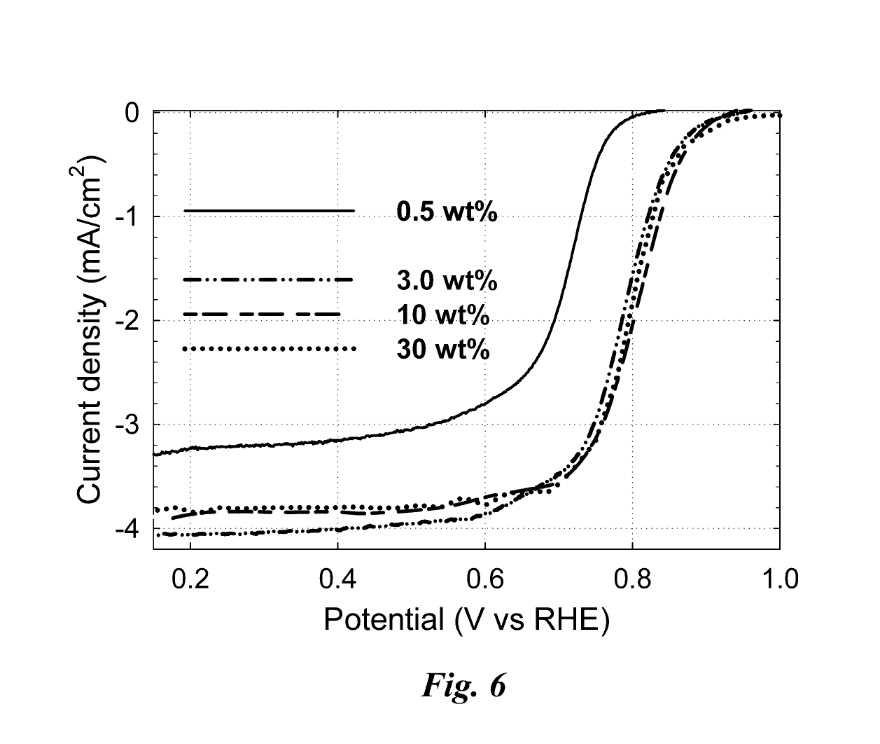

Effect of the metal loading. The addition of a metal precursor is necessary for the creation of highly active ORR catalysts, and the optimal amount must be determined for each catalyst type. The Fe content in the initial reaction mixture was varied from 0.5 wt % to 30 wt % while following the synthesis procedure described in the Experimental Section. Typical ORR activity curves of these catalysts are shown in FIG. 6. The ORR activity increases as the iron content increased from 0.5 wt % to 3 wt %, but the addition of more iron results in no statistically significant changes to the catalyst activity. At this point, a factor other than the iron supply limits the formation of active sites.

Compared to some previous reports, the amount of Fe required to generate the most active catalysts is relatively high at 3 wt %. For catalysts generated by reacting ammonia gas with carbon loaded with inorganic pre-cursors, only 0.2 wt % Fe is required for maximum activity. In the NH₃-generated catalysts, Fe is visualized to populate active sites that are associated with the micropores that have been formed by reaction of the disordered carbon phase with ammonia gas. For catalysts in this study, no ammonia gas was used and the details of active site formation differ. In particular, catalyst activity seems to be more strongly associated with carbon derived from the polymer than with any features of the original carbon-support material. As mentioned before, catalysts of similar activity could be obtained even with low surface area TiO₂ supports. Thus, the role of the metal in these catalysts appears to be associated with populating the active sites and also with forming the new carbon structures from the decomposed polymer (see SEM and TEM images in below section). This observation is consistent with the widespread use of transition-metal catalysts to generate carbon structures such as nanotubes in other fields of research. The need for a higher metal content than for other catalyst types can then be readily rationalized.

Because of the significant chemical transformations that occur with heat treatment, acid leaching, and a second heat treatment, the final Fe contents do not correspond to the initial ones, as shown in Table 1. Only a small amount of the Fe would be expected to participate in atomically-dispersed active sites, ≦0.2 wt %,⁹ so in all three cases a significant excess of Fe is present (2-12 wt %; see Table 1). These excess forms of Fe apparently respond differently to the acid-leaching (especially) and perhaps also the second heat treatment, depending on the amount of Fe originally present. The 10 wt % version of the catalyst was found to be the most reproducible in terms of activity, and was used for the results presented herein unless noted otherwise.

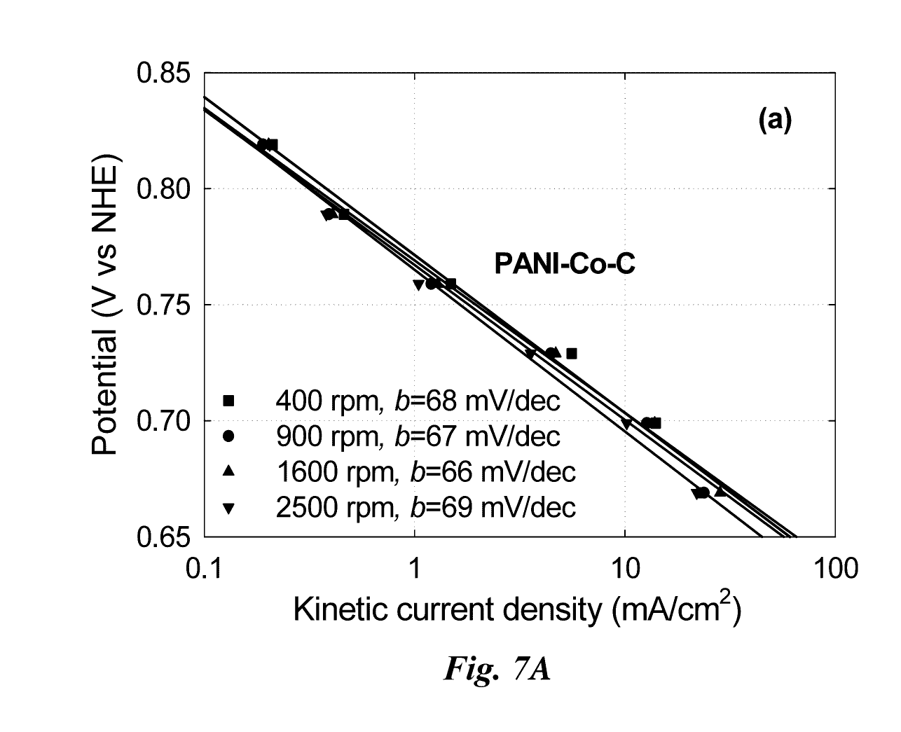

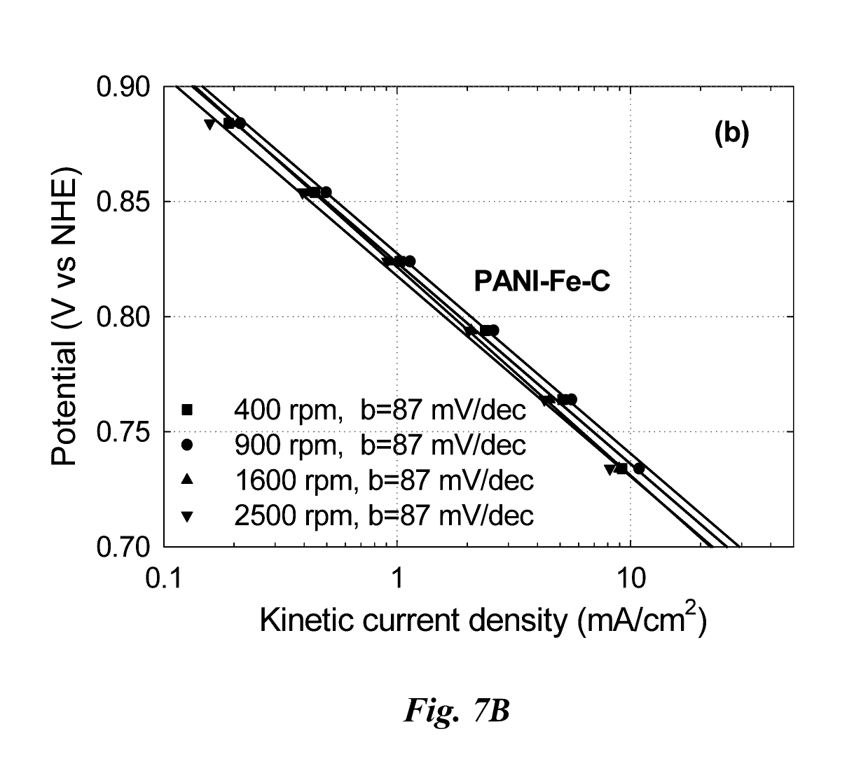

Effect of the transition metal. Besides the heat-treatment temperature, the ORR activities of PANI-derived catalysts are greatly dependent on the transition metals used in synthesis. Here Co and Fe salts were used to prepare PANI-Co—C and PANI-Fe—C catalysts, respectively. Their Tafel plots at various rotating speeds in oxygen-saturated 0.5 M H₂SO₄ electrolyte are compared in FIGS. 7A-7B. Some important parameters related to activity and kinetic analyses for both catalysts are compared in Table 2. The PANI-Fe—C catalyst is more active than the Co-based one for oxygen reduction according to RDE testing, showing an onset potential that is more than 100 mV positive and a half-wave potential that is 40 mV more positive. The calculated exchange current density of ORR on PANI-Fe—C(4×10⁻⁸ A cm⁻²) is nearly 100 times higher than that of PANI-Co—C catalyst (5×10⁻¹⁰ A cm⁻²). (Note that these values are necessarily based on extrapolation, and therefore may contain large errors, but the order of magnitude of the difference is correct.) The significant gaps between the RDE onset potentials and Tafel slopes of the two catalysts strongly suggest major differences between the two sets of active sites. Given that metal type and metal particle size influence the formation of carbon and nitrogen structures as well, in addition to the possibility that the metals participate in active sites directly, the exact nature of the difference cannot be simply specified.

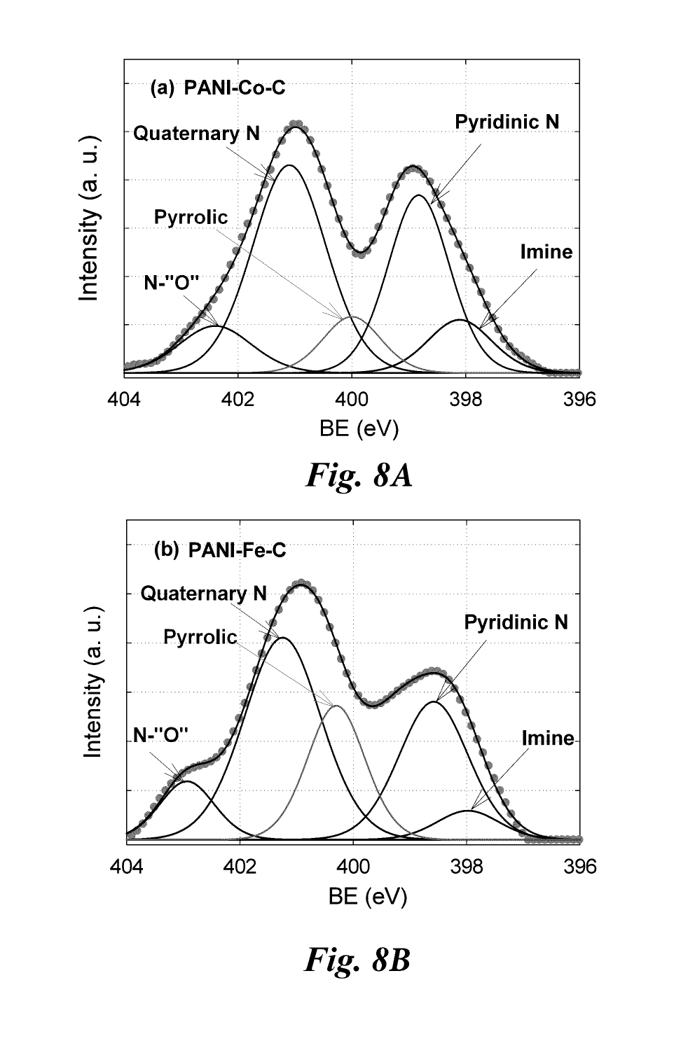

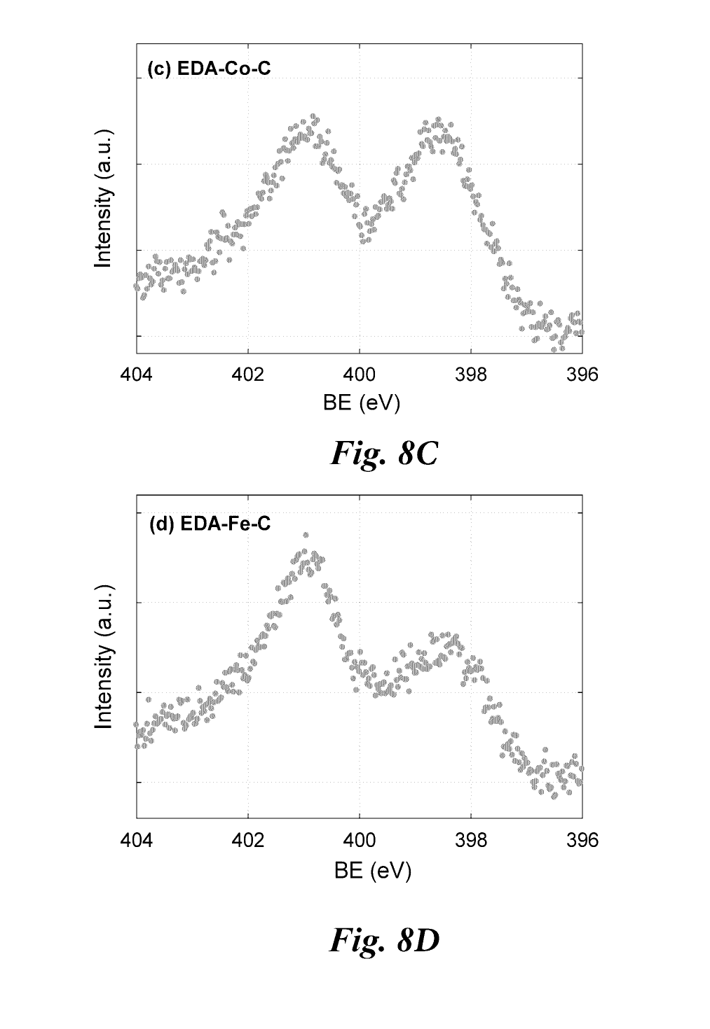

Since nitrogen incorporated into carbon is considered to be part of ORR active sites either with or without a bound metal center, the effect of transition metals on nitrogen speciation in PANI-derived catalysts was studied using XPS as shown in FIGS. 8A-8D. The replacement of Fe by Co leads to slightly higher pyridinic nitrogen content on both an absolute and relative basis. Since pyridinic nitrogen content is often correlated with ORR activity, this is a notable result. On the other hand, Fe increases the quaternary and pyrrolic nitrogen content slightly compared to Co on both relative and absolute scales. Similar observations were made for Fe and Co versions of an ethylene diamine (EDA)-derived catalyst(FIGS. 8A-8D). Pyrrolic nitrogen has seldom been correlated with ORR activity, and quaternary nitrogen has only recently been connected either experimentally or theoretically with ORR activity. The quaternary peak at ca. 401 eV can include contributions from graphitic nitrogen, pyridinium, and other nitrogen species (amines, amides), but since this sample has been heat-treated at 900° C., the graphitic nitrogen assignment is the most reasonable. Recently, a metal-free catalyst was reported with notable ORR activity showing only a single peak assigned to quaternary nitrogen in the N1s XPS spectrum, but the activity was much lower than the catalysts discussed here or others recently reported that were prepared using metal.

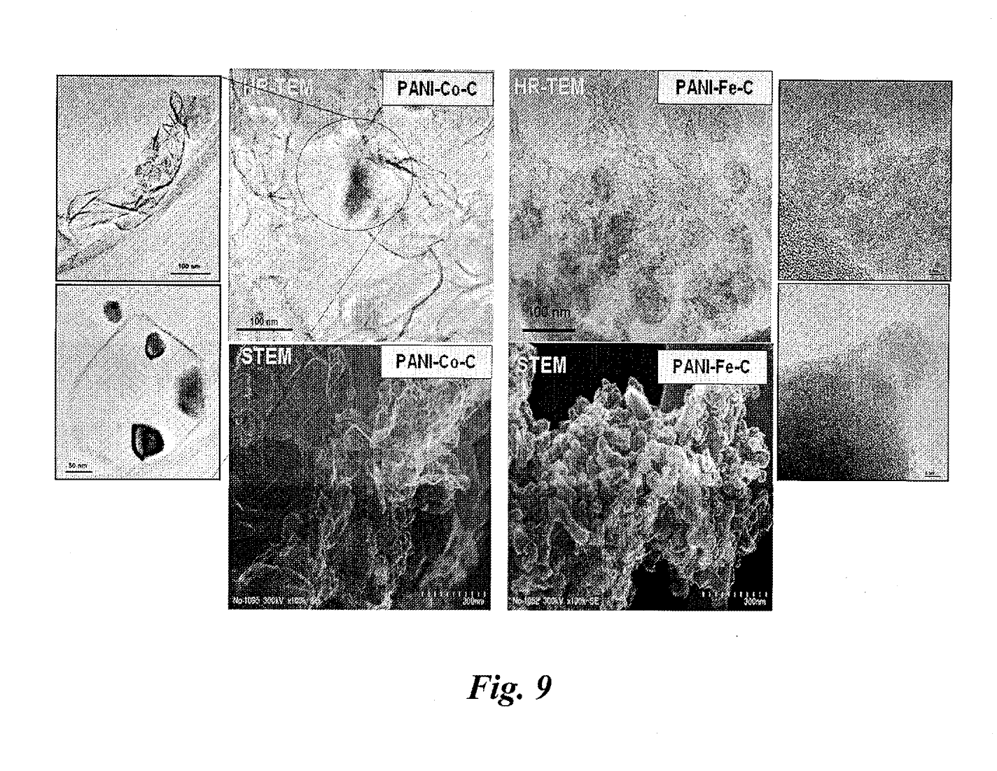

From the characterization study, it is known that nitrogen content of all types (pyridinic, pyrrolic, etc.) only weakly correlates with activity in these catalysts, implying the simultaneous importance of structural factors. To gain insight into the structural impact of choosing Fe versus Co, especially during the decomposition of PANI, the nanostructure and morphology of PANI-Fe and PANI-Co catalysts were studied using HR-TEM and STEM (FIG. 9). Graphene sheet structures are abundant in the PANI-Co—C catalyst (after heat-treatment, acid leaching, and a second heat-treatment), but not in the PANI-Fe—C powder. In both types of catalyst, the metal particles are coated with several layers of carbon (FIG. 9). These graphene sheets and carbon layers may or may not relate directly to ORR active sites, but they at least present a strong possibility given that the presence of Fe—N₄ centers embedded in graphene planes as determined by Mössbauer spectroscopy have been previously correlated to catalytic activity. The significant structural differences between the two catalysts demonstrate the strong effect of transition metal precursor selection on the carbon/nitrogen structures that result from the heat-treatment of polymers.

XRD patterns were obtained for samples at various points in the synthetic process when Fe and Co salts were used as metal precursors, respectively, and for a comparison sample prepared without transition metal (PANI-C), as shown in FIGS. 10A-10C. Metal-free samples including as-received carbon black, heat-treated carbon black and PANI-C are shown in FIG. 10A. These carbon samples all show a broad (002) peak at ca. 2θ=25°, which is typical of a highly disordered carbon. Heat treatment leads to an enhancement in the graphitic structure in carbon black as shown by the sharper peak, which is responsible for the observed improvement of ORR activity when compared with as-received carbon black. However, in the case PANI-C, the creation of disordered carbon from the PANI results in a symmetric broad (002) peak. Graphitization of the carbon black appears to have been inhibited. XRD patterns for the PANI-Co—C and PANI-Fe—C catalyst at different synthesis stages are compared in FIGS. 10B and 10C, respectively. Deposition of both PANI-Fe and PANI-Co onto carbon leads to the suppression of dominant carbon peaks at 25° and 44°, and the appearance of well-developed crystalline structures, assignable mainly to the excess of the oxidant (NH₄)₂S₂O₈ (2θ=17.6°, 22.2° and 26.6°). Broad polyaniline peaks are located at 15.8°, 20.4° and 24.6°. The virtual absence of peaks attributable to cobalt and iron salts suggests that Co and Fe ions are mostly coordinated by polyaniline or adsorbed onto the carbon supports. In the case of heat-treated PANI-Co—C sample, the peaks resulting from crystalline phases can be mainly assigned to Co₉S₈ (2θ=15.3°, 29.7°, 31.2°, 39.4°, 47.5° and 51.9°). Likewise, heat treatment results in the dominant formation of FeS (2θ=17.1°, 18.7°, 29.9°, 31.9°, 33.7°, 35.6°, 43.3°, 47.2°, 53.2° and 70.8°)⁵¹, with some lesser contributions from metallic Fe (2θ=44.8° and 64.2°) and Fe₃O₄ (2θ=41.9°, 56.3° and 63.1°) for the PANI-Fe—C case. After leaching these heat-treated samples in 0.5 M H₂SO₄ at 80° C. for 8 hours and performing a second heat treatment, the FeS in PANI-Fe—C greatly decreases, unlike the Co₉S₈ peaks in the PANI-Co—C catalyst. For the reduced iron content version of the sample used for the XAS experiments below (3 wt % vs. 10 wt %), the FeS peaks completely disappear. In contrast to the cobalt, much of the iron exists in a non-crystalline form, likely involving coordination with other species that survived the heat treatment and acid leach.

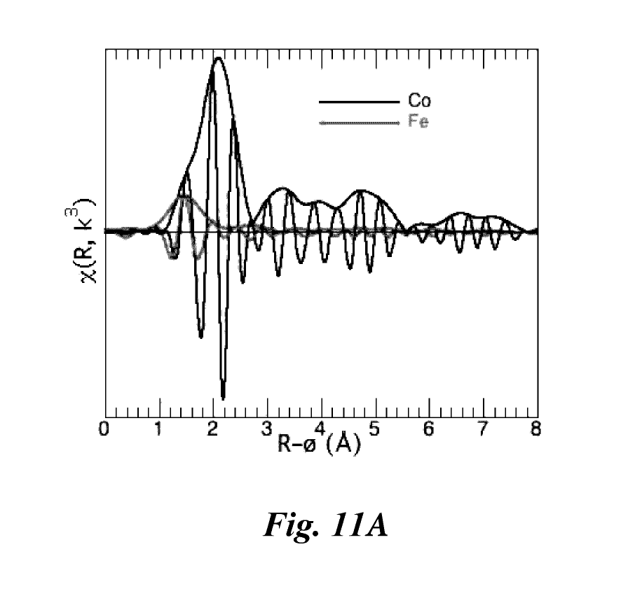

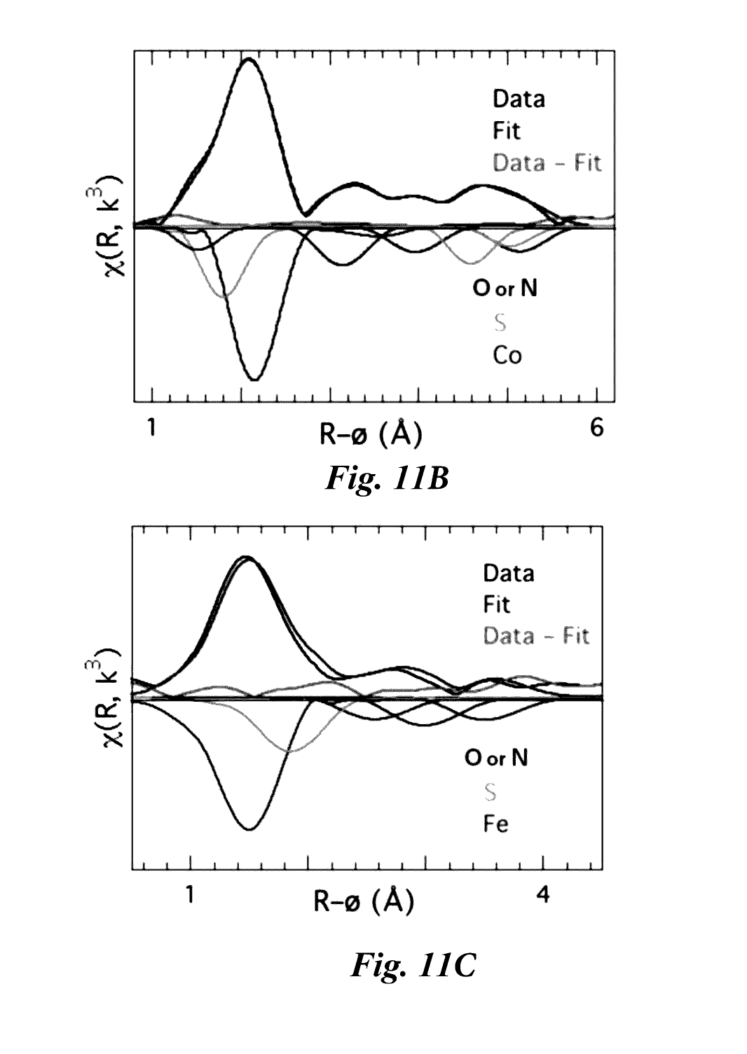

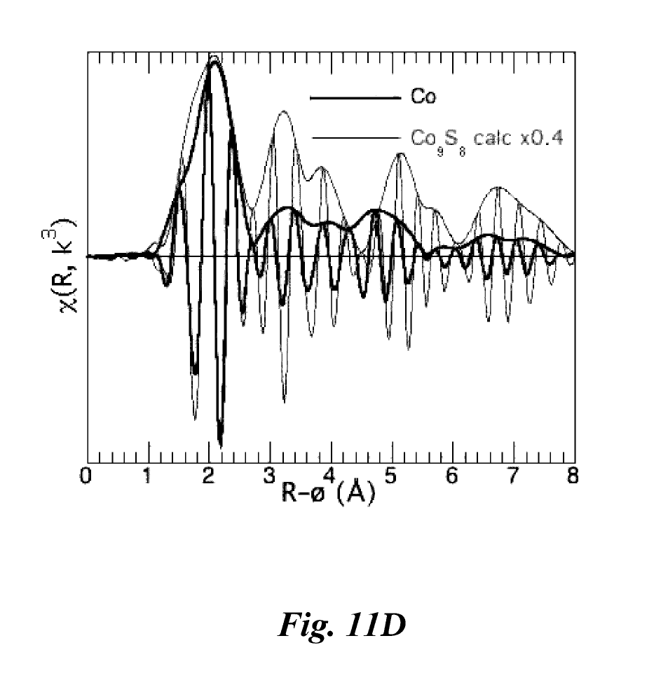

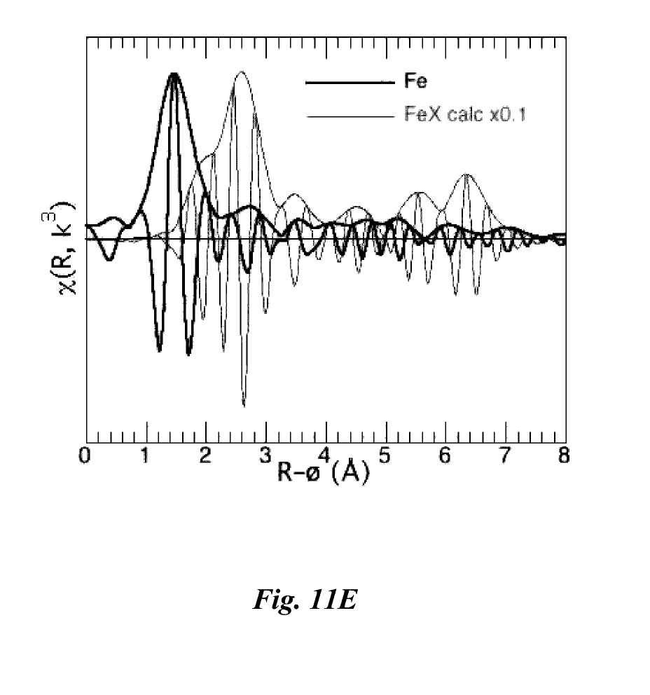

Ex-situ XAFS was used to analyze the coordination environment of transition metals in the PANI-Co—C and PANI-Fe—C catalysts (FIGS. 11A to 11E), in an attempt to identify non-crystalline species. Samples with 3 wt % Fe and Co content were prepared to decrease interference from spectator species versus the typical 10 wt % catalysts. (The 30 wt % catalysts, resulting in the lowest final metal content (Table 1), had not yet been developed.) The metal content of PANI-Co—C catalyst was similar to PANI-Fe—C at ca. 10 wt %. Overlaying the Fe and Co EXAFS (FIG. 11A, χ(R) representation) shows that the average environments of the two metals are completely different. The Fe spectrum displays only a single, low amplitude peak at short R and no long-range order, whereas the Co exhibits extended order and a nearest neighbor at a significantly longer distance. Both the PANI-Co—C and PANI-Fe—C EXAFS spectra (FIGS. 11B-11C) could be fit using metal, sulfur, and oxygen/nitrogen coordination shells. (The EXAFS signals from O and N in the local environment of the metal are equivalent to each other in these data, causing their contribution to be labeled O/N.) Consistent with the XRD, the Co EXAFS is well fit (FIG. 11B) by a series of neighbor shells that correspond well with those of Co₉S₈, as shown in FIG. 11D. This assignment is corroborated by the direct comparison of the experimental spectrum with that calculated for this compound. Although, unsurprisingly, the EXAFS of the Co in the catalyst material is lower in amplitude and thus less ordered than the pure mineral, it is nevertheless evident that the preponderance of the Co resides in the Co₉S₈ found by diffraction with only a small fraction in other form. These other forms, however, are likely to be important because bulk Co₉S₈ is not the origin of the ORR activity. It is therefore worth noting the relatively small O shell at 1.5 Å and the possible S shell at 1.8 Å that does not belong to Co₉S₈. The most prominent feature in the Fe EXAFS is the near neighbor peak at R=1.5 Å that is well fit primarily by an O/N at 1.6 Å, a distance typical of the Fe—N₄ structures that occur in N-based macrocyclic ligands. The fit also finds a sulfur shell at 1.8 Å and then the possibility of Fe shells at longer distances. However, a direct comparison of the experimental EXAFS with that calculated for FeS (FIG. 11E) as a candidate iron sulfide analogous to the formation of a cobalt sulfide via the same preparation method indicates that FeS does not contain a significant amount of the Fe in the material.

Fe—Nₓ bonds can certainly be considered, then, as a strong possibility for the dominant Fe structure in the PANI-Fe—C catalyst, whereas Co—Nₓ bonds are clearly not the dominant Co structure in the PANI-Co—C catalyst. Co—Nₓ bonds may be present at a sufficiently high number to remain candidates for active sites, however, given that the overall intensity of the RDF is much larger for PANI-Co—C than for PANI-Fe—C(FIG. 11A). In other words, the shell attributed to Co—(O/N) coordination is non-negligible when compared on an absolute scale to the PANI-Fe—C RDF.

### Examples

Catalyst synthesis. Ketjenblack EC 300J (KJ-300J) was used as the support in the catalyst synthesis. The carbon samples were pre-treated in an aqueous HCl solution for 24 hours to remove the surface impurities. 2.0 mL aniline was first dispersed with 0.4 g acid-treated carbon black in 0.5 M HCl solution. The suspension was kept cold, below 10° C., while the oxidant (ammonium peroxydisulfate (APS), (NH₄)₂S₂O₈) and transition metal precursors (FeCl₃ or Co(NO₃)₂.6H₂O) were added. After constant mixing for 24 hours to allow the now polymerized aniline, i.e. polyaniline (PANI) to uniformly mix and cover the carbon black particles, the suspension containing carbon, polymer and transition metal(s) was vacuum-dried using a rotary evaporator. The subsequent heat treatment was performed at temperatures ranging from 400° C. to 1000° C. in an inert atmosphere of nitrogen gas for one hour. The heat-treated sample was acid-leached in 0.5 M H₂SO₄ at 80° C. for 8 hours to remove unstable and inactive species from the catalyst, and then thoroughly washed in de-ionized water. In the final step, the catalyst was heat-treated again under identical conditions to the first heat treatment.

RDE/RRDE testing. Rotating disk electrode (RDE) and rotating ring-disk electrode (RRDE) testing were performed using a CHI Electrochemical Station (Model 750b) in a conventional three-electrode cell at a rotating disk speed of 900 rpm at room temperature. The catalyst loading on RDE was controlled at 0.6 mg cm⁻². A graphite-rod and Ag/AgCl (3 M NaCl, 0.235 V vs. RHE (measured value)) were used as the counter and reference electrodes, respectively. ORR steady-state polarization curves were conducted in oxygen-saturated 0.5 M H₂SO₄ electrolyte with a potential step of 0.03 V and a period of 30 s.

In RRDE testing, the ring potential was set to 1.2 V. Before experiments, the Pt ring was activated by potential cycling in 0.5 M H₂SO₄ from 0.0 V to 1.4 V at a scan rate of 50 mV s⁻¹ for 10 minutes. Four-electron selectivity of catalysts was evaluated based on H₂O₂ yields, calculated from the following equation,

$${H}_{2} {O}_{2} ( \% ) = 200 \frac{{I}_{R} / N}{( {I}_{R} / N ) + {I}_{D}} \qquad ( 1 )$$

where I_{D} and I_{R} are the disk and ring currents, respectively, and N is the ring collection efficiency.

Fuel cell testing. Non-precious metal catalysts were tested at the fuel cell cathode for ORR activity and durability under PEFC operating conditions. Catalyst “inks” were prepared by ultrasonically mixing catalyst powders with Nafion® solution for four hours. Cathode “inks” were applied to the gas diffusion layer (GDL, ELAT LT 1400W, E-TEK) by successive brushing until the cathode catalyst loading of ˜4 mg cm⁻² was reached. The NAFION® content in the dry catalyst was maintained at ca. 30 wt %. A commercially-available Pt-catalyzed cloth gas-diffusion layer (E-TEK, 0.25 mg cm⁻² Pt) was used at the anode without any further processing. The cathode and anode were hot-pressed with a NAFION® 1135 membrane to fabricate the membrane-electrode assembly (MEA). The geometric area of the MEA was 5.0 cm². Fuel cell testing was carried out in a single cell with single-serpentine flow channels. Hydrogen and oxygen/air, humidified at 90° C., were supplied to the anode and cathode at a flow rate of 200 and 400 mL/min, respectively. Both electrodes were maintained at the same backpressure of 2.8 bar (˜3.5 bar absolute pressure at Los Alamos altitude). Fuel cell polarization plots were recorded using standard fuel cell test stations (FUEL CELL TECHNOLOGIES INC.).

Physical characterization. Mid-infrared spectra were recorded on a NICOLET 670 FTIR spectrometer on KBr pellets. The crystallinity of various samples was determined by X-ray diffraction (XRD) using a BRUKER AXS D8 Advance diffractometer with Cu Kα radiation. X-ray photoelectron spectroscopy (XPS) was performed at the University of New Mexico on a KRATOS Axis Ultra spectrometer using a Al Kα monochromatic X-ray source (with an emission voltage of 12 kV and an emission current of 20 mA. The sample morphology was characterized by scanning electron microscopy (SEM) on a Hitachi S-5400 instrument. High-resolution transmission electron microscopy (HR-TEM) images were taken on a JEOL 3000F microscope operating at 300 kV at Oak Ridge National Laboratory. Thermogravimetric analysis was performed using a TA Q50 instrument. The temperature was ramped at 5° C./min to 1000° C. and held until mass change was less than 0.05%/min, then ramped down to 25° C. at 30° C./min during which time <0.5% mass change was observed. The residual powder was determined to be Fe₂O₃ by XRD. The mass of Fe₂O₃ was then used to calculate the Fe content of the sample. Fe and Co K edge X-ray Absorption Fine Structure (XAFS) measurements were performed at the Stanford Synchrotron Radiation Lightsource, on beam lines 11-2 and 10-2, using conventional fluorescence mode procedures. Data were analyzed and interpreted using standard procedures, with emphasis on using similar processing parameters. Metrical parameters were obtained from χ(k) by nonlinear least squares curve-fitting using amplitudes and phases calculated by FeFF.

TABLE 1
Fe content as determined by TGA and/or ICP.

| Expected | Measured | Fe content of |
|---|---|---|
| initial Fe content | initial Fe content | as-synthesized |
| (based on | (before 1^{st} heat | catalyst (after 2^{nd} |
| calculation) | treatment) | heat treatment) |
| 3.0 wt % | 4.3 wt % (TGA & | 10 wt % (TGA) |
| | ICP) | |
| 10 wt % | 12 wt % (TGA & | 12 wt % (TGA & |
| | ICP) | ICP) |
| 30 wt % | 20 wt % (TGA) | 2 wt % (TGA) |

TABLE 2
Parameters of ORR activity and kinetic
analysis for PANI-derived catalysts.

| | | | | Tafel | |
|---|---|---|---|---|---|
| | Onset | Half-wave | H₂O₂ | slope | |
| | potential | potential | yield | (mV | j^{o} |
| Catalysts | (V) | (V) | at 0.40 V | dec⁻¹) | (A cm⁻²) |
| PANI-Co—C | 0.81 | 0.73 | 7% | 67 | 5 × 10⁻¹⁰ |
| PANI-Fe—C | 0.91 | 0.77 | 1% | 87 | 4 × 10⁻⁸ |

In all embodiments of the present invention, all percentages are by weight of the total composition, unless specifically stated otherwise. All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of producing a catalyst suitable for use in a membrane electrode assembly, comprising:
a) providing a mixture comprising a polyaniline precursor and a catalyst support;
b) adding to said mixture an oxidant and a compound comprising a transition metal;
c) agitating said mixture sufficiently to result in polyaniline polymerization;
d) drying the mixture;
e) heating the dried mixture in an inert atmosphere at a temperature of from about 400° C. to about 1000° C.; and thereafter
f) leaching the mixture with an acid solution; and thereafter
g) heating the mixture in an inert atmosphere at a temperature of from about 400° C. to about 1000° C.

2. The method of claim 1, wherein the catalyst support comprises carbon black, multi-walled carbon nanotubes, non-carbon supports, and combinations thereof.

3. The method of claim 2, wherein the catalyst support further comprises TiO₂, Al₂O₃, or combinations thereof.

4. The method of claim 1, wherein the mixture comprising the polyaniline precursor and the catalyst support is an acidic mixture.

5. The method of claim 1, wherein the oxidant is ammonium peroxydisulfate.

6. The method of claim 1, wherein the transition metal is cobalt, iron, or combinations thereof.

7. The method of claim 1, wherein the heating temperature for each heating is from about 800° C. to about 900° C.

8. The method of claim 1, further comprising adding to the mixture a solution comprising a perfluorinated sulfonic acid ionomer to produce a catalyst ink.

9. The method of claim 8, further comprising applying the catalyst ink to a component of a membrane electrode assembly.

10. A composition produced by a process comprising:
forming a cold aqueous suspension of carbon and aniline,
forming a first product by combining the suspension with an oxidant and a transition metal-containing compound and allowing the resulting mixture to react under conditions suitable for polymerization of the aniline to polyaniline, the transition metal containing compound including a metal selected from iron and cobalt,
drying the first product,
heating the dry first product at a temperature of from about 400° C. to about 1000° C. to form a second product,
leaching the second product with acid, and thereafter
repeating the step of heating at a temperature of from about 600° C. to about 1000° C. to form a third product.

11. The composition of claim 10, wherein the heating temperature for each heating is from is from about 800° C. to about 900° C.

12. The composition of claim 10, wherein the process further comprises combining the third product with a solution including a perfluorinated sulfonic acid ionomer.

13. The composition of claim 12, wherein the heating temperature for each heating is about 900° C.

14. A membrane electrode assembly comprising a catalyst prepared by a process comprising:
a) providing a mixture comprising a polyaniline precursor and a catalyst support;
b) adding to said mixture an oxidant and a compound comprising a transition metal;
c) agitating said mixture sufficiently to result in polyaniline polymerization;
d) drying the mixture;
e) heating the dried mixture in an inert atmosphere at a temperature of from about 400° C. to about 1000° C.; and thereafter
f) leaching the mixture with an acid solution; and thereafter
g) heating the mixture in an inert atmosphere at a temperature of from about 400° C. to about 1000° C. to form a product, and thereafter
combining the mixture with a solution including a perfluorinated sulfonic acid ionomer.

15. The membrane electrode assembly of claim 14, wherein the catalyst support comprises carbon black, multi-walled carbon nanotubes, non-carbon supports, and combinations thereof.

16. The membrane electrode assembly of claim 14, wherein the catalyst support further comprises TiO₂, Al₂O₃, or a combination thereof.

17. The membrane electrode assembly of claim 14, wherein the mixture comprising the polyaniline precursor and the catalyst support is an acidic mixture.

18. The membrane electrode assembly of claim 14, wherein the oxidant is ammonium peroxydisulfate.

19. The membrane electrode assembly of claim 14, wherein the transition metal is cobalt, iron, or a combination thereof.

20. The membrane electrode assembly of claim 14, wherein the temperature for each heating is from about 800° C. to about 900° C.
